(19) United States
(12) Patent Application Publication
(10) Pub. No.: US 2026/0366894 A1
(43) Pub. Date: Nov. 19, 2026

(54) SENSOR MOUNT AND SENSOR CONFIGURED TO COUPLE TO THE SAME

(71) Applicant: ABL IP Holding, LLC, Atlanta, GA (US)

(72) Inventors: John R. JOHNSON, Flowery Branch, GA (US); Gomez Sam SELVARAJ, Grayson, GA (US)

(21) Appl. No.: 19/209,905

(22) Filed: May 16, 2025

(51) Int. Cl. G01D 11/24

(52) U.S. Cl. CPC G01D 11/245

(57) ABSTRACT

A sensor assembly may include an assembly base and a sensor module removably coupled to the assembly base. The sensor module may have a field of view and may be electrically coupled to the assembly base. At least a portion of the sensor module may be configured to rotate relative to the assembly base about a sensor axis to adjust a position of the field of view. The sensor module may remain electrically coupled to the assembly base during the rotation about the sensor axis.

### TECHNICAL FIELD

The present disclosure is generally directed to sensor assemblies and more specifically to a sensor mount and a sensor configured to couple to the same.

### BACKGROUND INFORMATION

A building can include one or more environmental systems (e.g., lighting systems, heating/cooling systems, fire detection and/or mitigation systems, and/or any other environmental system) controlled by one or more external devices such as a building management system and/or by one or more components of a corresponding system (e.g., by one or more individual light fixtures of a lighting system). The building management system can be configured to be communicatively coupled to one or more sensors. The output of the one or more sensors can be used by the building management system to adjust one or more of the environmental systems. The sensor type, sensor placement, and/or sensor orientation may vary based on the conditions being sensed and/or a configuration of a room within which the sensor is placed.

The orientation and/or placement of the one or more sensors may influence an efficacy of the one or more sensors. For example, when the one or more sensors include a motion sensor configured to detect motion within a room, improper orientation and/or positioning of the motion sensor may result in an at least partially obstructed field of view for the motion sensor and/or a field of view that excludes one or more areas of interest. A partially obstructed field of view and/or a field of view that excludes one or more areas of interest may result in the motion sensor failing to detect motion within the room. When output from the motion sensor is used by the building management system (or a light fixture) to selectively activate one or more lighting systems, failure to detect motion may result in the building management system (or the light fixture) failing to activate one or more lighting systems in response to an individual entering the room.

In some instances, the one or more sensors may be included with a light fixture. In these instances, the orientation and/or placement of the one or more sensors is dictated by the position and orientation of the light fixture. As a result, the field or view of the one or more sensors may be at least partially obstructed and/or not include one or more areas of interest. For example, the position and orientation of the light fixture may result in the field of view of a motion sensor not including a high traffic area and/or entryway to a room.

### BRIEF DESCRIPTION OF THE DRAWINGS

These and other features and advantages will be better understood by reading the following detailed description, taken together with the drawings, wherein:

FIG. 1 shows a schematic example of a sensor assembly coupled to a light fixture, consistent with embodiments of the present disclosure.

FIG. 2 shows a schematic top view of the sensor assembly and light fixture of FIG. 1 within a room, consistent with embodiments of the present disclosure.

FIG. 2A shows a schematic example of a field of view for a sensor assembly that is discontinuous over a view angle of the sensor assembly, consistent with embodiments of the present disclosure.

FIG. 3 shows a perspective view of a sensor assembly, consistent with embodiments of the present disclosure.

FIG. 3A shows a perspective view of the sensor assembly of FIG. 3 coupled to a light fixture, consistent with embodiments of the present disclosure.

FIG. 4 shows a perspective view of the sensor assembly of FIG. 3, wherein a sensor module is removed from an assembly base of the sensory assembly, consistent with embodiments of the present disclosure.

FIG. 5 shows a perspective view of the assembly base of FIG. 4, consistent with embodiments of the present disclosure.

FIG. 6 shows a cross-sectional view of the assembly base of FIG. 4, consistent with embodiments of the present disclosure.

FIG. 7 shows a bottom perspective view of the sensor module of FIG. 4, consistent with embodiments of the present disclosure.

FIG. 8 shows a cross-sectional perspective view of the sensor module of FIG. 4, consistent with embodiments of the present disclosure.

FIG. 9 shows a perspective view of the sensor assembly of FIG. 3, wherein a sensor module has been replaced with a base cover, consistent with embodiments of the present disclosure.

### DETAILED DESCRIPTION

The present disclosure is generally directed to a sensor assembly configured to be coupled to a light fixture. The sensor assembly includes an assembly base and a sensor module removably coupled and electrically coupled to the assembly base. At least a portion of the sensor module is rotatable relative to the assembly base to adjust a field of view of the sensor module. In some instances, the sensor module is configured to remain electrically coupled to the assembly base while the field of view is adjusted.

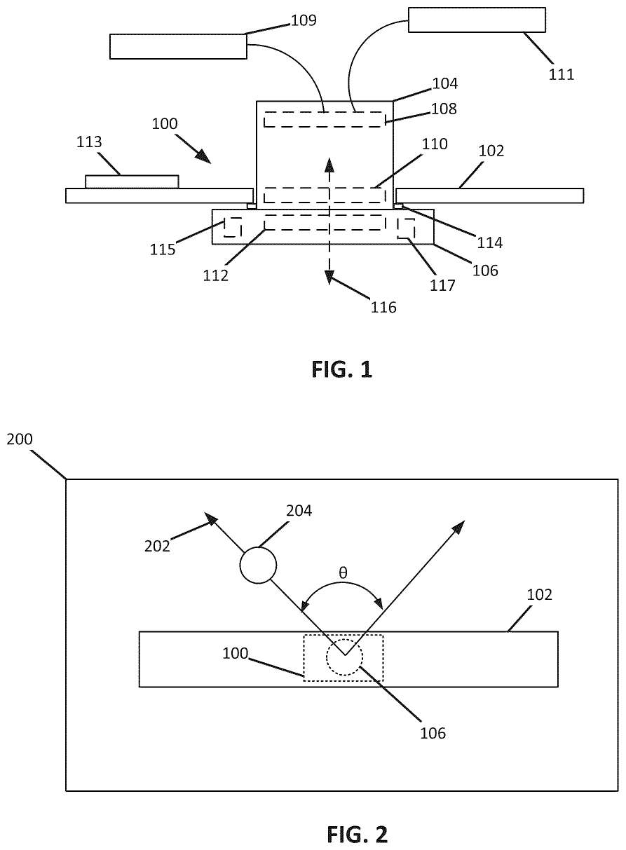

FIG. 1 shows a schematic example of a sensor assembly 100 coupled to a light fixture 102 (e.g., a ceiling light fixture) in a room. As shown, the sensor assembly 100 includes an assembly base 104 configured to couple to the light fixture 102 and a sensor module 106 configured to be removably coupled and electrically coupled to the assembly base 104. The assembly base 104 includes a building side electrical connector 108 configured to electrically couple to a building power supply 109 (e.g., via the light fixture 102) and a sensor side electrical connector 110 configured to electrically couple to the sensor module 106. The building side electrical connector 108 is electrically coupled to the sensor side electrical connector 110 such that power is provided to the sensor module 106.

The sensor module 106 includes a base side electrical connector 112, a base mechanical connector 114, and a sensor 117 for sensing one or more environmental conditions and generating an output corresponding to the sensed conditions. The sensor 117 can be electrically coupled to the base side electrical connector 112. The base side electrical connector 112 is configured to electrically couple to the sensor side electrical connector 110 of the assembly base 104. The base mechanical connector 114 is configured to cooperate with the assembly base 104 to selectively mechanically couple the sensor module 106 to the assembly base 104. Such a configuration may allow the sensor module 106 to be removed for replacement (e.g., with the same or different sensor type) and/or repair.

The building side electrical connector 108 may be further configured to be communicatively coupled to a building management system 111 such that the building management system 111 controls operation of the light fixture 102 (e.g., based, at least in part, on outputs from the sensor module 106). Alternatively, the building side electrical connector 108 may be configured to only deliver power to the light fixture 102 and to not communicatively couple to the building management system 111. In these instances, the building management system 111 and/or another external device may be configured to directly or indirectly wirelessly couple to the light fixture 102.

The building side electrical connector 108 can be configured to be electrically coupled to the sensor module 106 (e.g., for power and/or communication) through an electrical connection formed between the sensor side electrical connector 110 and the base side electrical connector 112. In some instances, the sensor side electrical connector 110 may be communicatively coupled to a fixture controller 113 of the light fixture 102, wherein the fixture controller 113 is configured to control operation of the light fixture 102 (e.g., based, at least in part, on outputs from the sensor module 106 as received via the electrical coupling between sensor side and base side electrical connectors 110 and 112). Additionally, or alternatively, the sensor module 106 may include a sensor controller 115 configured to, at least partially, control the light fixture 102 via the electrical coupling between the sensor side and base side electrical connectors 110 and 112. For example, the sensor controller 115 may receive an output generated by the sensor 117 of the sensor module 106 and generate an output that is provided to the light fixture 102 (e.g., the fixture controller 115). In some instances, the sensor module 106 may be configured to communicate (e.g., wirelessly) with an external device (e.g., a smartphone, a tablet computer, a desktop computer, a building management system, a laptop computer, and/or the like) to control one or more aspects of the light fixture 102. Use of the fixture controller 113 and/or the sensor controller 115 to control the light fixture 102 may allow the light fixture 102 to be operated independently of the building management system 111. Such a configuration may allow for installation of the light fixture 102 in, for example, a smaller setting that may not include the building management system 111.

At least a portion of (e.g., the entire) the sensor module 106 can be configured to rotate relative to the assembly base 104 about a sensor axis 116. The sensor axis 116 extends transverse to (e.g., perpendicular or non-perpendicular to) a mounting surface (e.g., a wall or ceiling of a room) to which the light fixture 102 is coupled. For example, at least a portion of sensor module 106 may be configured to be rotated about the sensor axis 116 while maintaining an electrical and/or mechanical coupling with the assembly base 104. Such a configuration allows the orientation of at least a portion of the sensor module 106 to be adjusted. For example, when the sensor module 106 has a field of view that is less than 360°, adjusting the orientation of at least a portion of the sensor module 106 may allow the field of view of the sensor module 106 to be positioned to include an area of interest.

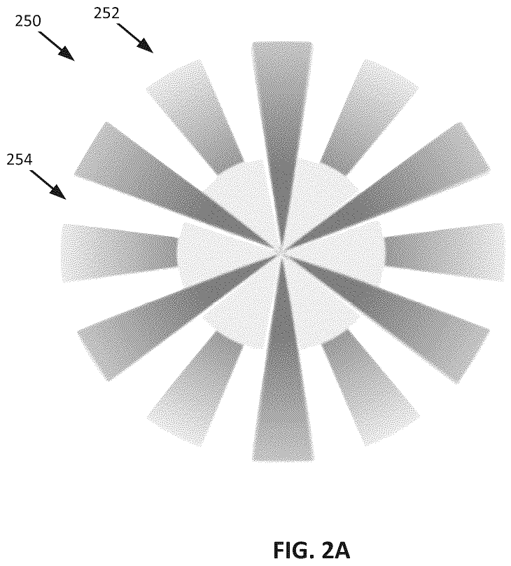

FIG. 2 shows a schematic top view of the sensor assembly 100 coupled to the light fixture 102 within a room 200. As shown, the sensor module 106 has a field of view 202 having a view angle θ that is less than 360°. The field of view 202 can be adjusted to include one or more areas of interest 204 (e.g., a doorway, a high traffic area, and/or the like). For example, at least a portion of the sensor module 106 may be rotated through a rotation angle to adjust the position of the field of view 202. In this example, when the light fixture 102 is initially installed within the room 200, the field of view 202 may not include (e.g., completely include) the one or more areas of interest 204. As such, a position of the field of view 202 may be adjusted by rotation of at least a portion of the sensor module 106 rather than repositioning the light fixture 102. Such a configuration may improve installation flexibility of the light fixture 102. While the field of view 202 is shown as being continuous, other configurations are possible. For example, the field of view 202 may include a plurality of view segments that are spaced apart by a non-detection zone, wherein the sensor module 106 is capable of detection of a condition (e.g., motion or light) within the view segments and not capable of detection of the condition in the non-detection zone. In this example, the field of view 202 would be discontinuous over the view angle θ. FIG. 2A shows one example of a field of view 250 that includes a plurality of view segments 252 separated by corresponding non-detection zones 254 such that the field of view 250 is discontinuous over a view angle of 360°.

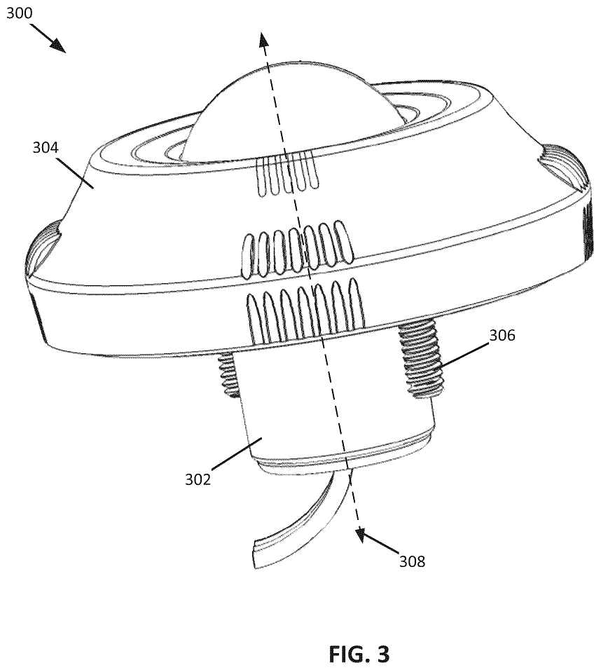

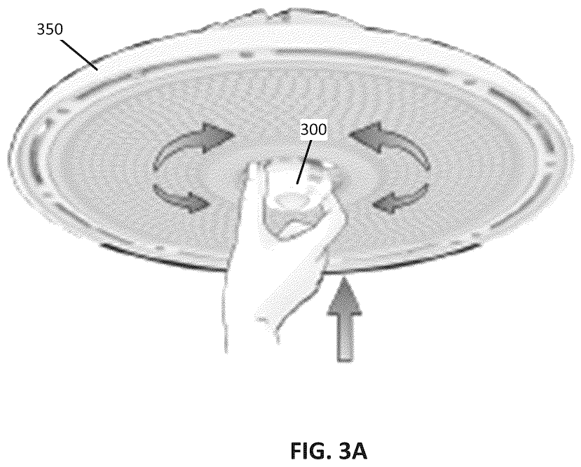

FIG. 3 shows a perspective view of a sensor assembly 300 configured to be coupled to a light fixture (e.g., the light fixture 102 of FIG. 1). The sensor assembly 300 is an example of the sensor assembly 100 of FIG. 1. FIG. 3A shows one example of the sensor assembly 300 coupled to a light fixture 350.

As shown, the sensor assembly includes an assembly base 302 and a sensor module 304 removably coupled to the assembly base 302. The assembly base 302 is configured to couple to a light fixture (e.g., using fasteners 306). At least a portion of the sensor module 304 is configured to rotate relative to the assembly base 302. For example, at least a portion of the sensor module 304 can be configured to rotate about a sensor axis 308 (e.g., to selectively couple the sensor module 304 to the assembly base 302 and/or to adjust a field of view of the sensor module 304). The sensor axis 308 can extend transverse to (e.g., at a perpendicular or non-perpendicular angle) the assembly base 302. At least a portion of the sensor module 304 can be configured to rotate in a first and/or a second rotation direction through a rotation angle (e.g., an angle less than 360°).

In some instances, the sensor assembly 300 may be configured to wirelessly communicate with an external device (e.g., a smartphone, a tablet computer, a desktop computer, a building management system, a laptop computer, and/or the like). Such a configuration may allow the light fixture to which the sensor assembly 300 is coupled to be communicatively coupled to external devices without having to run additional wiring within a building that is dedicated to communication. In some instances, the sensor assembly 300 may be configured to send and/or receive Radio Frequency (RF) waves in compliance with for example a Zigbee protocol, a Bluetooth protocol, a Wi-Fi protocol, a Z-Wave protocol, and/or any other RF communication protocol. In some instances, the RF waves may have a frequency of about 900 megahertz. Additionally, or alternatively, the sensor assembly 300 may be configured to send and/or receive data according to one or more line-of-sight communication protocols (e.g., using optical signals such as infrared signals). Communication with the sensor assembly 300 (wired and/or wireless) may allow behaviors of a corresponding light fixture to be adjusted and/or programming of the sensor assembly 300 to be changed (e.g., a schedule for hours of operation, sensitivity settings, and/or the like). In some instances, the sensor assembly 300 may be configured to have one or more settings adjusted prior to receiving power (e.g., to allow for one or more settings to be adjusted before installation).

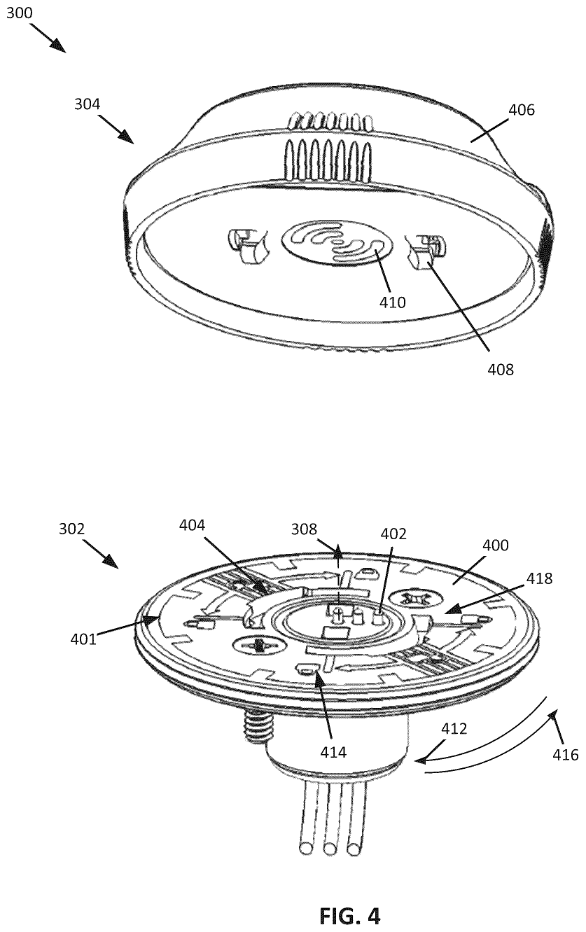

FIG. 4 shows a perspective view of the sensor assembly 300 of FIG. 3, wherein the sensor module 304 has been separated from the assembly base 302. As shown, the assembly base 302 includes a mounting plate 400 and a plurality of base electrical contacts 402. The mounting plate 400 includes one or more attachment slots 404 configured to cooperate with the sensor module 304 to removably couple the sensor module 304 with the mounting plate 400. The one or more attachment slots 404 can include a first locked position 414 and a second locked position 418 configured to removably couple the sensor module 304 with the assembly base 302, the first locked position 414 being spaced apart from the second locked position 418. In other words, the mounting plate 400 may be generally described as being configured to removably couple the sensor module 304 with the assembly base 302.

The sensor module 304 includes a module housing 406, one or more attachment arms 408, and a plurality of sensor electrical contacts 410. The attachment arms 408 are configured to be slidably and removably received within the attachment slots 404 to removably couple the sensor module 304 with the mounting plate 400. In other words, the attachment arms 408 may be generally described as being configured to removably couple the sensor module 304 to the assembly base 302. The sensor electrical contacts 410 are configured to electrically couple with the base electrical contacts 402 to electrically couple the assembly base 302 with the sensor module 304 (e.g., to allow for the transmission of power and/or data between the assembly base 302 and the sensor module 304). Rotation of at least a portion of the sensor module 304 about the sensor axis 308 can cause at least one of the sensor electrical contacts 410 to move relative to at least one of the base electrical contacts 402. In the example shown, the base electrical contacts 402 are in the form of contact pins (e.g., pogo pins) and the sensor electrical contacts 410 are in the form of contact pads configured to engage the contact pins. However, other configurations are possible. For example, the base electrical contacts 402 can be in the form of contact pads and the sensor electrical contacts 410 can be in the form of contact pins.

The base electrical contacts 402 and the sensor electrical contacts 410 are configured to remain electrically coupled to each other as the attachment arms 408 slide within the attachment slots 404 to selectively couple the sensor module 304 to the assembly base and/or to adjust a field of view of the sensor module 304. For example, and as shown, the sensor module 304 may be selectively rotated in a first rotation direction 412 towards the first locked position 414 or in a second rotation direction 416 towards the second locked position 418. The first rotation direction 412 can be opposite the second rotation direction 416. While rotating in either direction, the electrical coupling between the base electrical contacts 402 and the sensor electrical contacts 410 is maintained. As should be appreciated, when the sensor module 304 is rotated to the first locked position 414, a field of view of the sensor module 304 is at a first location and, when the sensor module 304 is rotated to the second locked position 418 the field of view of the sensor module 304 is at a second location, the second location being different from the first location. In this way, the field of view of the sensor module 304 may be adjusted.

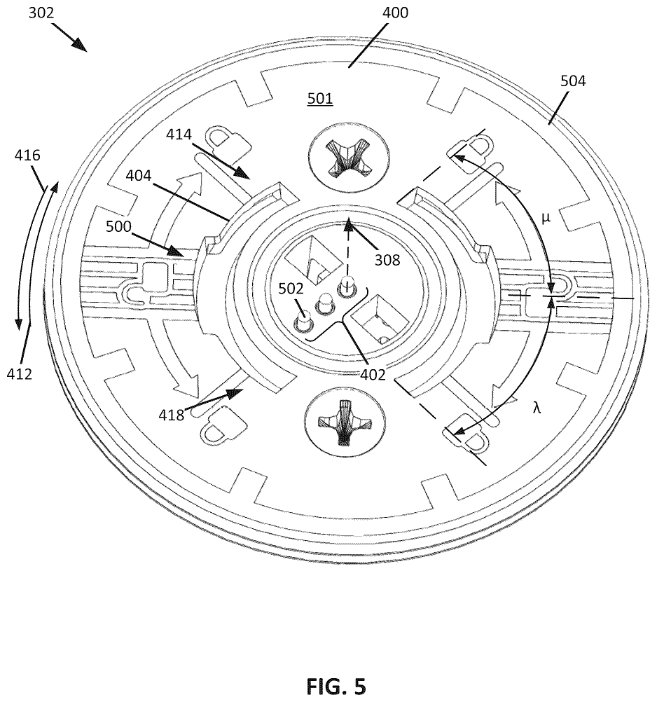

FIG. 5 shows a perspective view of the assembly base 302. As shown, the mounting plate 400 includes a plurality of attachment slots 404. The attachment slots 404 have an arcuate shape. The arcuate shape of the attachment slots 404 may be centered on the sensor axis 308 such that rotation of the sensor module 304 (FIG. 3) causes movement of the attachment arms 408 (FIG. 4) within the attachment slots 404 along an arcuate path. As shown, the sensor axis 308 extends transverse to (e.g., perpendicular or non-perpendicular to) a mounting surface 501 of the mounting plate 400.

Each attachment slot 404 includes an unlocked position 500. At the unlocked position 500, the attachment arms 408 are removable from (and insertable into) the attachment slot 404 to removably couple the sensor module 304 to the assembly base 302. Rotation of the sensor module 304 in the first or second rotation direction 412 or 416 causes the attachment arms 408 to move towards the first or second locked position 414 or 418, respectively. The first and second locked positions 414 and 418 may each be configured to selectively retain the attachment arms 408 at the first or second locked position 414 or 418. For example, the first and/or second locked positions 414 and/or 418 may form a friction fit and/or snap fit with the attachment arms 408 to selectively retain the attachment arms 408 at the first or second locked position 414 or 418.

As shown, the first and second locked positions 414 and 418 are angularly displaced from the unlocked position 500 by a first angular displacement λ and a second angular displacement μ, respectively. The first and second angular displacements λ and μ may be the same or different. The first and/or second angular displacements λ and μ may be, for example, in a range of 5° to 90°. By way of further example, the first and/or second angular displacements λ and μ may be in a range of 25° to 65°. By way of still further example, the first and/or second angular displacements λ and μ may be in a range of 40° to 50°. By way of still further example, the first and/or second angular displacements λ and μ may be about (e.g., within 10% of, 5% of, 4% of, 3% of, 2% of, or 1% of) 45°. In this example, the first locked position 414 may be generally described as being angularly spaced apart from the second locked position 418 by about 90°.

In some instances, there may be one or more intermediary stop positions between the unlocked position 500 and the first and second locked positions 414 and 418. The one or more intermediary stop positions may be configured to selectively retain the attachment arms 408 at the one or more intermediary stop positions. Inclusion of intermediary stop positions may allow for further adjustment of the field of view of the sensor module 304.

While the unlocked position 500 is shown as being positioned between the first and second locked positions 414 and 418 such that a rotation of the sensor module 304 in the first rotation direction 412 causes the attachment arms 408 to move towards the first locked position 414 and a rotation of the sensor module 304 in the second rotation direction 416 causes the attachment arms 408 to move towards the second locked position 418, other configurations are possible. For example, the unlocked position 500 can be disposed at a distal end of the attachment slot 404 and the first locked position 414 may be positioned along the attachment slot 404 between the unlocked position 500 and the second locked position 418. In this example, rotation of the sensor module 304 in only one of the first or second rotation directions 412 or 416 causes the attachment arms 408 to move away from the unlocked position 500 and towards the first and/or second locked positions 418. In other words, in this example, one of the first or second rotation directions 412 or 416 may be generally described as a locking direction and the other of the first or second rotation directions 412 or 416 may be generally described as an unlocking direction. As such, in this example, the total angular displacement when traversing (according to the locking direction) from the unlocked position 500 to the first unlocked position 414 and from the first unlocked position 414 to the second unlocked position 418, may be the sum of the first and second angular displacements λ and μ.

As further shown, the base electrical contacts 402 include at least three spaced apart contact pins 502 (e.g., pogo pins). One of the three contact pins 502 can be disposed at (e.g., extend along) the sensor axis 308 and the other two contact pins 502 may be disposed radially outward of the sensor axis 308. In other words, at least three contact pins 502 can be radially spaced apart from each other, wherein one of the contact pins 502 is centrally disposed relative to the mounting plate 400. Each of the three contact pins 502 can be biased to encourage a consistent electrical coupling between the three contact pins 502 and the sensor electrical contacts 410 (FIG. 4). In some instances, at least one of the contact pins 502 may be a ground pin, at least one of the contact pins 502 may be a power pin, and at least one of the contact pins 502 may be a communication/data pin. While the base electrical contacts 402 are shown as including at least three spaced apart contact pins 502, other configurations are possible. For example, the base electrical contacts 402 may include at least two spaced apart contact pins 502. In this example, power and data may be provided using a common contact pin 502 (e.g., using the LEDCode Protocol).

The assembly base 302 can further include a seal 504. The seal 504 can be coupled to the mounting plate 400 (e.g., by overmolding) such that the seal 504 extends around a periphery 401 of the mounting plate 400 (e.g., to enclose the mounting plate 400). The seal 504 can be configured to sealingly engage with the module housing 406 (FIG. 4) of the sensor module 304. For example, the seal 504 can be configured to impede (e.g., prevent) an ingress of debris (e.g., dust or water) into the sensor module 304 at an interface extending between the sensor module 304 (e.g., the module housing 406) and the assembly base 302.

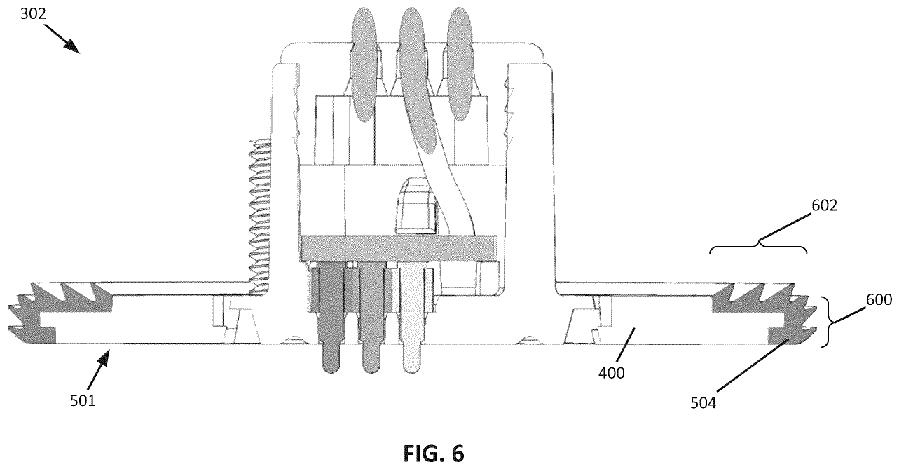

With additional reference to FIG. 6, the seal 504 can include one or more housing engaging ribs 600 and one or more fixture engage ribs 602. The one or more housing engaging ribs 600 are configured to sealingly engage with the module housing 406. The one or more fixture engaging ribs 602 are configured to sealingly engage with a light fixture (e.g., the light fixture 102 of FIG. 1 or the light fixture 350 of FIG. 3A). As such, the seal 504 can be generally described as being configured to impede (e.g., prevent) an ingress of debris (e.g., dust or water) into one or more of the sensor module 304 and/or the light fixture.

The one or more housing engaging ribs 600 may have an annular shape (e.g., flared annular shape) that extends radially outwardly from the mounting plate 400. For example, and as shown, the one or more housing engaging ribs 600 may have a flared annular shape that is configured to encourage the coupling of the sensor module 304 with the assembly base 302. In this example, the flared annular shape of the one or more housing engaging ribs 600 may be configured to encourage the one or more housing engaging ribs 600 to bend towards a flattened orientation when being received within the module housing 406.

The one or more fixture engaging ribs 602 may have an annular shape (e.g., a flared annular shape) that extends transverse (e.g., perpendicular or non-perpendicular) to the mounting surface 501 of the mounting plate 400. For example, the one or more fixture engaging ribs 602 may have a flared annular shape that is configured encourage the compression and/or bending of the one or more fixture engaging ribs 602 when the assembly base 302 is coupled to a light fixture (e.g., using fasteners 306 of FIG. 3). In this example, the flared annular shape of the one or more fixture engaging ribs 602 may be configured to encourage the one or more fixture engaging ribs 602 to bend towards a flattened orientation.

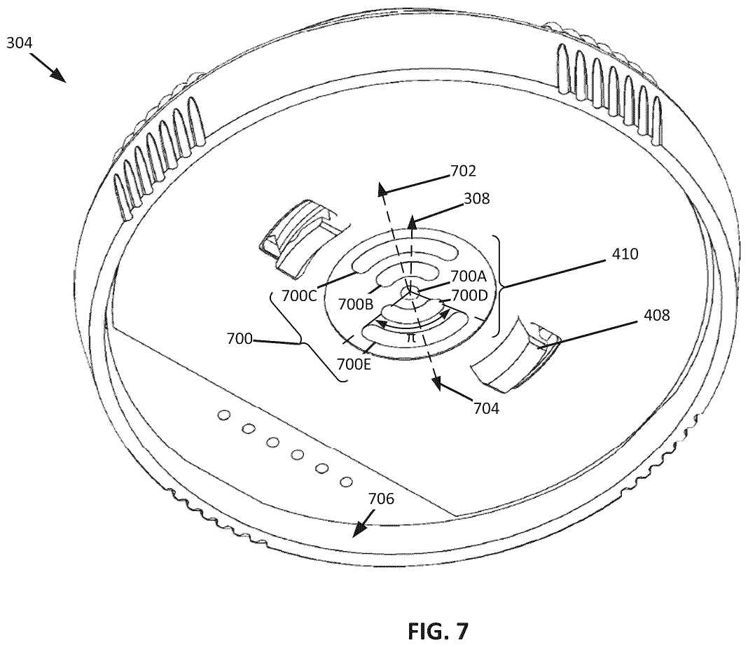

FIG. 7 shows a bottom perspective view of the sensor module 304. As shown, the sensor electrical contacts 410 include at least three spaced apart contact pads 700A-C. One of the three contact pads (e.g., a central contact pad) 700A can be disposed at the sensor axis 308 and the other two contact pads 700B and 700C may be disposed radially outward of the sensor axis 308 (and central contact pad 700A). In some instances, the sensor electrical contacts 410 may include at least two contacts pads. For example, the at least two contact pads 700 may include the central contact pad 700A and one of the contact pads 700B or 700C. By way of further example, the at least two contact pads 700 may include the contact pads 700B and 700C. In this example, the contact pads 700 may positioned to be symmetrical relative to the sensor axis 308, allowing for rotation of the sensor module 304 about the sensor axis 308 while maintaining an electrical coupling between the base electrical contacts 402 (FIG. 4) and the sensor electrical contacts 410. In examples having two contact pads 700, power and data may be provided using a common contact pad 700 (e.g., using the LEDCode Protocol).

In some instances, the sensor electrical contacts 410 may include at least five contact pads 700A-E. In these instances, one of the five contact pads 700A (a central contact pad) can be disposed at the sensor axis 308, two of the five contact pads 700B and 700C may be disposed radially outward of the sensor axis 308 along a first radial direction 702, and two of the five contact pads 700D and 700E may be disposed radially outward of the sensor axis 308 along a second radial direction 704. The first and second radial directions 702 and 704 may be opposite directions (e.g., and colinear). In other words, a first and a second contact pad 700B and 700C may be at a first side of the central contact pad 700A and a third and fourth contact pad 700D and 700E may be at a second side of the central contact pad 700A, wherein the first, second, third, and fourth contact pads 700B-E are spaced apart and disposed radially outward of the central contact pad 700A. When the first, second, third, and fourth contact pads 700B-E have an arcuate shape, at least two arcuate contact pads 700B-E may be disposed on opposing sides of the central contact pad 700A (e.g., such that the contact pads 700B-E are centered on the central contact pad 700A). Having at least five contact pads 700A-E (as opposed to three contact pads 700A-C) may make coupling of the sensor module 304 to the assembly base 302 (FIG. 2) at least partially orientation independent (e.g., as long as the attachment arms 408 are capable of being received within a corresponding attachment slot 404, FIG. 4, an electrical coupling between the sensor module 304 and assembly base 302 will be established). For example, a first contact pin 502 can correspond to the central contact pad 700A, a second contact pin 502 can correspond to one of the first or third contact pad 700B or 700D, and a third contact pin 502 can correspond to one of the second or fourth contact pad 700C or 700E. When coupling of the sensor module 304 to the assembly base 302 is at least partially orientation independent, the adjustability of the field of view and/or ease of installation of the sensor module 304 may be improved.

At least three of the contacts pads 700 can be configured to maintain an electrical coupling with a corresponding contact pin 502 (FIG. 5) as the sensor module 304 is rotated towards the first or second locked position 414 or 418 (FIG. 4). In other words, at least one contact pin 502 may be caused to slide along a corresponding contact pad 700B-E in response to rotation about the sensor axis 308. For example, the contact pads 700B-E that are spaced radially from the sensor axis 308 may have an arcuate shape along which a corresponding contact pin 502 is capable of moving (e.g., sliding) as the sensor module 304 is rotated towards the first or second locked position 414 or 418. In this example, the contact pads 700B-E may have an arcuate shape that is centered on the sensor axis 308. In some instances, at least one of the contact pads 700 may be a ground pad, at least one of the contact pads 700 may be a power pad, and at least one of the contact pads 700 may be a communication/data pad.

The arcuate contact pads 700B-E have an arc angle π. The arc angle π may be substantially (e.g., within 10% of, 5% of, 4% of, 3% of, 2% of, or 1% of) the same as a sum of the first and second angular displacements λ and μ of the first and second locked positions 414 and 418. For example, when the first and second angular displacements λ and μ (FIG. 5) are about 45° the arc angle π may be about 90°.

While the sensor electrical contacts 410 are shown as including the central contact pad 700A and at least two arcuate contact pads 700B and 700C and/or 700D and 700E spaced radially from the central contact pad 700A, other configurations are possible. For example, the sensor electrical contacts 410 may include the central contact pad 700A and at least one of the arcuate contact pads 700B or 700C and/or at least one of the arcuate contact pads 700D or 700E. In this example, power and data may be provided using a common contact pad 700 (e.g., using the LEDCode Protocol).

Further, while the contact pads 700 and the contact pins 502 are each shown as having a central pad or central pin, respectively, other configurations are possible. For example, each of the contact pads 700 and the contact pins 502 may be radially spaced apart from the sensor axis 308 and configured such that each contact pad 700 maintains an electrical coupling with a corresponding contact pin 502 during rotation of the sensor module 304 about the sensor axis 308. In this example, the sensor electrical contacts 410 may be positioned on opposing sides of the sensor axis 308 in a symmetrical configuration.

As further shown, the module housing 406 may include a sealing surface 706. The sealing surface 706 may have an annular shape (e.g., that extends continuously). The sealing surface 706 is configured to sealingly and slidingly engage the one or more housing engaging ribs 600 (FIG. 6) of the seal 504 (FIG. 5).

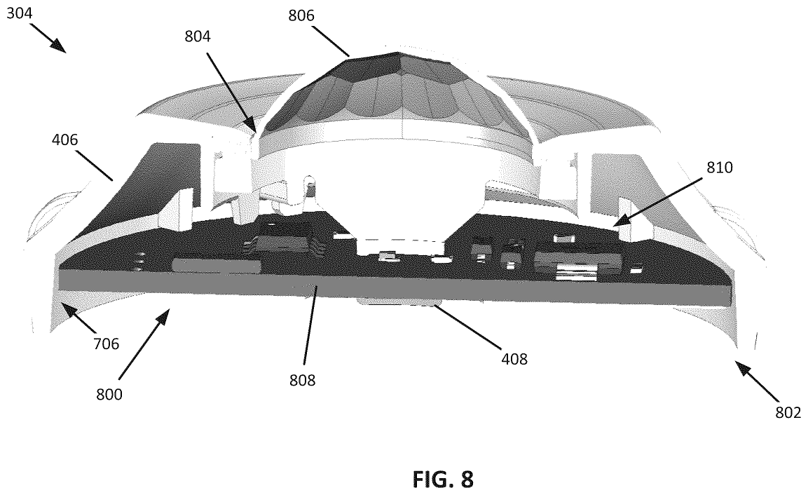

FIG. 8 shows a perspective cross-sectional view of the sensor module 304. As shown, the module housing 406 includes a housing cavity 800 having a base opening 802 defined by the sealing surface 706 and a sensing opening 804 that is opposite the base opening 802. The sensing opening 804 may include a sensor transparent cover 806 through which environmental conditions may be sensed. For example, the sensor transparent cover 806 may be configured to be at least partially transparent to one or more wavelengths of light (e.g., in the human visible and/or infrared spectrum).

The base opening 802 is configured such that a sensor printed circuit board (PCB) 808 can pass therethrough such that the sensor PCB 808 can be disposed within the housing cavity 800. As shown, when the sensor PCB 808 is received within the housing cavity 800, the attachment arms 408 pass through the sensor PCB 808 (e.g., to couple to the sensor PCB 808 to the module housing 406). When the sensor module 304 is coupled to the assembly base 302 (FIG. 3), at least a portion of the seal 504 (FIG. 5) is disposed between the sensor PCB 808 and the base opening 802.

The sensor PCB 808 includes the sensor electrical contacts 410 (e.g., the at least five contact pads 700A-E of FIG. 7) and one or more sensing components 810 electrically coupled to the sensor electrical contacts 410 (e.g., for communication and/or power). The one or more sensing components 810 may be configured such that the sensor module 304 can be used to sense one or more of ambient light (e.g., light within the human visible spectrum), motion, occupancy (e.g., as detected by motion, by temperature, by images, and/or the like), temperature, humidity, smoke (e.g., in the event of a fire), and/or any other environmental condition capable of being sensed. In one example, the one or more sensing components 810 may include an occupancy sensor and an ambient light sensor, wherein output from the occupancy sensor is used to activate at least one light fixture and output from the ambient light sensor is configured to set an intensity of the light fixture when activated.

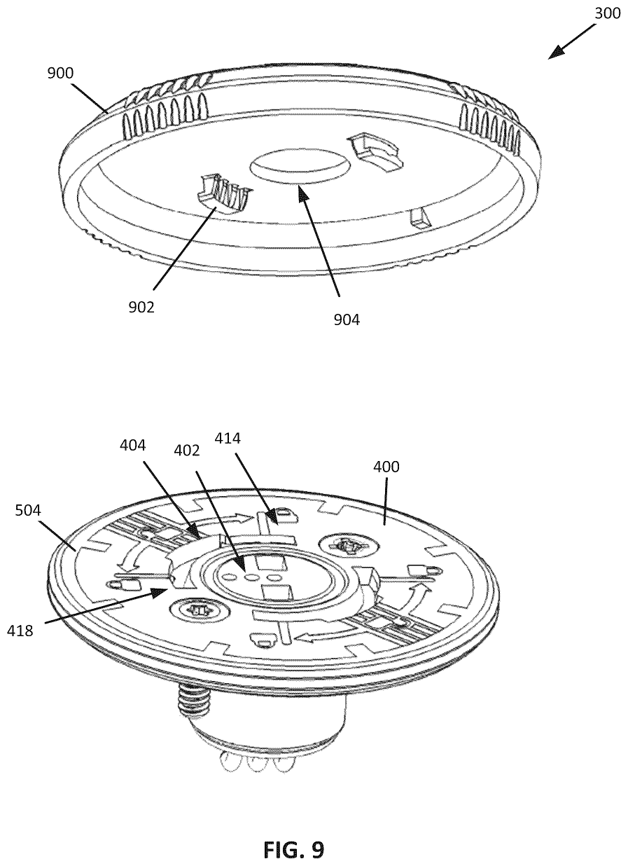

FIG. 9 shows a perspective exploded view of the sensor assembly 300, wherein the sensor module 304 has been replaced with a base cover 900. As shown, the base cover 900 includes one or more cover arms 902 configured to be received within and slidably engage with corresponding attachment slots 404 of the mounting plate 400. When received within the corresponding attachment slots 404, the one or more cover arms 902 may move to one of the first or second locked position 414 or 418 in response to rotation of the base cover 900 relative to the mounting plate 400. The base cover 900 may be configured to sealingly engage with at least a portion of the seal 504 when coupled to the mounting plate 400.

As further shown, the base cover 900 may include a passthrough 904. The passthrough 904 can positioned within the base cover 900 such that the base electrical contacts 402 are exposed through the passthrough 904. The base cover 900 may allow for light fixtures to be configured to selectively include a sensor module 304, while maintaining a desired aesthetic appearance of the light fixtures that do not include the sensor module 304.

An example of a sensor assembly, consistent with the present disclosure, may include an assembly base and a sensor module removably coupled to the assembly base. The sensor module may have a field of view and may be electrically coupled to the assembly base. At least a portion of the sensor module may be configured to rotate relative to the assembly base about a sensor axis to adjust a position of the field of view. The sensor module may remain electrically coupled to the assembly base during the rotation about the sensor axis.

In some instances, assembly base may include a plurality of base electrical contacts and the sensor module may include a plurality of sensor electrical contacts, the plurality of base electrical contacts and the plurality of sensor electrical contacts electrically coupling the assembly base with the sensor module. In some instances, the rotation about the sensor axis may cause at least one of the sensor electrical contacts to move relative to at least one of the base electrical contacts. In some instances, the plurality of base electrical contacts may include a plurality of contact pins and the plurality of sensor electrical contacts may include a plurality of contact pads, at least one contact pin being configured to slide along a corresponding contact pad in response to the rotation about the sensor axis. In some instances, the assembly base may include a mounting plate configured to removably couple the sensor module to the assembly base. In some instances, the assembly base may further include a seal coupled to the mounting plate, the seal being configured to impede an ingress of debris into the sensor module. In some instances, the rotation about the sensor axis may selectively couple the sensor module to the assembly base. In some instances, the rotation about the sensor axis may include selectively rotating in a first rotation direction towards a first locked position or in a second rotation direction towards a second locked position to adjust the field of view and to selectively couple the sensor module to the assembly base. In some instances, the rotation about the sensor axis may include rotating towards at least one of a first locked position or a second locked position to adjust the field of view and to selectively couple the sensor module to the assembly base. In some instances, the first locked position may be angularly spaced apart from the second locked position by about 90° and the first rotation direction is opposite the second rotation direction. In some instances, the sensor module includes at least five contact pads, the at least five contact pads including a central contact pad, the central contact pad being located on the sensor axis, a first and a second contact pad disposed at a first side of the central contact pad, and a third and a fourth contact pad disposed at a second side of the central contact pad, each of the first, second, third, and fourth contact pads being spaced apart and disposed radially outward of the central contact pad. In some instances, the first, second, third, and fourth contact pads may have an arcuate shape. In some instances, the arcuate shape of the first, second, third, and fourth contact pads may be centered on the central contact pad. In some instances, the assembly base may include a first contact pin configured to correspond to the central contact pad, a second contact pin configured to correspond to the first and third contact pads, and a third contact pin configured to correspond to the second and fourth contact pads. In some instances, the sensor module includes at least three contact pads, the at least three contact pads may include a central contact pad, the central contact pad being located on the sensor axis, a first contact pad disposed at a first side of the central contact pad, and a second contact pad disposed at a second side of the central contact pad, each of the first and second contact pads being spaced apart and disposed radially outward of the central contact pad. In some instances, the first and second contact pads may have an arcuate shape centered on the central contact pad and the assembly base may include a first contact pin configured to correspond to the central contact pad and a second contact pin configured to correspond to the first and second contact pads.

An example of a sensor module for removably coupling to an assembly base, consistent with the present disclosure, may include a module housing including a housing cavity, the housing cavity having a base opening and a sensing opening, one or more attachment arms configured to removably couple the sensor module to the assembly base, and a sensor Printed Circuit Board (PCB) disposed within the housing cavity. The sensor PCB may include one or more sensing components and at least five contact pads, the at least five contact pads including a central contact pad, a first and a second contact pad disposed at a first side of the central contact pad, and a third and a fourth contact pad disposed at a second side of the central contact pad, each of the first, second, third, and fourth contact pads being spaced apart and disposed radially outward of the central contact pad.

In some instances, the first, second, third, and fourth contact pads may have an arcuate shape. In some instances, the arcuate shape of the first, second, third, and fourth contact pads may be centered on the central contact pad. In some instances, the sensing opening may include a sensor transparent cover.

An example of an assembly base for removably coupling to a sensor module, consistent with the present disclosure, may include a mounting plate including at least one attachment slot that includes a first locked position spaced apart from a second locked position, the attachment slot having an arcuate shape, a seal coupled to the mounting plate such that the seal extends around a periphery of the mounting plate, and at least three contact pins radially spaced apart from each other, wherein one of the contact pins is centrally disposed relative to the mounting plate.

In some instances, the at least three contact pins may be pogo pins. In some instances, the seal may include one or more housing engaging ribs having a flared annular shape and one or more fixture engaging ribs having a flared annular shape.

Another example of a sensor module for removably coupling to an assembly base, consistent with the present disclosure, may include a module housing including a housing cavity, the housing cavity having a base opening and a sensing opening, one or more attachment arms configured to removably couple the sensor module to the assembly base, and a sensor Printed Circuit Board (PCB) disposed within the housing cavity, the sensor PCB including one or more sensing components and at least three contact pads. The at least thee contact pads may include a central contact pad, a first contact pad disposed at a first side of the central contact pad, and a second pad disposed at a second side of the central contact pad, each of the first and second contact pads being spaced apart and disposed radially outward of the central contact pad.

In some instances, the first and second contact pads may have an arcuate shape. In some instances, the arcuate shape of the first and second contact pads may be centered on the central contact pad. In some instances, the sensing opening may include a sensor transparent cover.

Another example of an assembly base for removably coupling to a sensor module, consistent with the present disclosure, may include a mounting plate including at least one attachment slot that includes a first locked position spaced apart from a second locked position, the attachment slot having an arcuate shape, a seal coupled to the mounting plate such that the seal extends around a periphery of the mounting plate, and at least two contact pins radially spaced apart from each other, wherein one of the contact pins is centrally disposed relative to the mounting plate.

In some instances, the at least two contact pins may be pogo pins. In some instances, the seal may include one or more housing engaging ribs having a flared annular shape and one or more fixture engaging ribs having a flared annular shape.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A sensor assembly comprising:
an assembly base; and
a sensor module removably coupled to the assembly base, the sensor module having a field of view and being electrically coupled to the assembly base, at least a portion of the sensor module being configured to rotate relative to the assembly base about a sensor axis to adjust a position of the field of view, wherein the sensor module remains electrically coupled to the assembly base during the rotation about the sensor axis.

2. The sensor assembly of claim 1, wherein the assembly base includes a plurality of base electrical contacts and the sensor module includes a plurality of sensor electrical contacts, the plurality of base electrical contacts and the plurality of sensor electrical contacts electrically coupling the assembly base with the sensor module.

3. The sensor assembly of claim 2, wherein the rotation about the sensor axis causes at least one of the sensor electrical contacts to move relative to at least one of the base electrical contacts.

4. The sensor assembly of claim 3, wherein the plurality of base electrical contacts include a plurality of contact pins and the plurality of sensor electrical contacts include a plurality of contact pads, at least one contact pin being configured to slide along a corresponding contact pad in response to the rotation about the sensor axis.

5. The sensor assembly of claim 1, wherein the assembly base includes a mounting plate configured to removably couple the sensor module to the assembly base.

6. The sensor assembly of claim 5, wherein the assembly base further includes a seal coupled to the mounting plate, the seal being configured to impede an ingress of debris into the sensor module.

7. The sensor assembly of claim 5, wherein the rotation about the sensor axis selectively couples the sensor module to the assembly base.

8. The sensor assembly of claim 7, wherein the rotation about the sensor axis includes rotating towards at least one of a first locked position or a second locked position to adjust the field of view and to selectively couple the sensor module to the assembly base.

9. The sensor assembly of claim 8, wherein the first locked position is angularly spaced apart from the second locked position by about 90°.

10. The sensor assembly of claim 1, wherein the sensor module includes at least five contact pads, the at least five contact pads including:
a central contact pad, the central contact pad being located on the sensor axis;
a first and a second contact pad disposed at a first side of the central contact pad; and
a third and a fourth contact pad disposed at a second side of the central contact pad, each of the first, second, third, and fourth contact pads being spaced apart and disposed radially outward of the central contact pad.

11. The sensor assembly of claim 10, wherein the first, second, third, and fourth contact pads have an arcuate shape.

12. The sensor assembly of claim 11, wherein the arcuate shape of the first, second, third, and fourth contact pads is centered on the central contact pad.

13. The sensor assembly of claim 12, wherein the assembly base includes a first contact pin configured to correspond to the central contact pad, a second contact pin configured to correspond to the first and third contact pads, and a third contact pin configured to correspond to the second and fourth contact pads.

14. The sensor assembly of claim 1, wherein the sensor module includes at least three contact pads, the at least three contact pads including:
a central contact pad, the central contact pad being located on the sensor axis;
a first contact pad disposed at a first side of the central contact pad; and
a second contact pad disposed at a second side of the central contact pad, each of the first and second contact pads being spaced apart and disposed radially outward of the central contact pad.

15. The sensor assembly of claim 14, wherein the first and second contact pads have an arcuate shape centered on the central contact pad and the assembly base includes a first contact pin configured to correspond to the central contact pad and a second contact pin configured to correspond to the first and second contact pads.

16. A sensor module for removably coupling to an assembly base comprising:
a module housing including a housing cavity, the housing cavity having a base opening and a sensing opening;
one or more attachment arms configured to removably couple the sensor module to the assembly base; and
a sensor Printed Circuit Board (PCB) disposed within the housing cavity, the sensor PCB including one or more sensing components and at least three contact pads, the at least three contact pads including:
a central contact pad;
a first contact pad disposed at a first side of the central contact pad; and
a second contact pad disposed at a second side of the central contact pad, each of the first and second contact pads being spaced apart and disposed radially outward of the central contact pad.

17. The sensor module of claim 16, wherein the first and second contact pads have an arcuate shape.

18. The sensor module of claim 17, wherein the arcuate shape of the first and second contact pads is centered on the central contact pad.

19. The sensor module of claim 16, wherein the sensing opening includes a sensor transparent cover.

20. An assembly base for removably coupling to a sensor module comprising:
a mounting plate including at least one attachment slot that includes a first locked position spaced apart from a second locked position, the attachment slot having an arcuate shape;
a seal coupled to the mounting plate such that the seal extends around a periphery of the mounting plate; and
at least two contact pins radially spaced apart from each other, wherein one of the contact pins is centrally disposed relative to the mounting plate.

21. The assembly base of claim 20, wherein the at least two contact pins are pogo pins.

22. The assembly base of claim 20, wherein the seal includes one or more housing engaging ribs having a flared annular shape and one or more fixture engaging ribs having a flared annular shape.
